(19) United States
(12) Patent Application Publication
(10) Pub. No.: US 2012/0164463 A1
(43) Pub. Date: Jun. 28, 2012

(54) CYANATE ESTER RESIN COMPOSITION, AND PREPREG AND LAMINATE MADE THEREFROM

(75) Inventors: Junqi Tang, Dongguan City (CN); Xianping Zeng, Dongguan City (CN)

(73) Assignee: GUANGDONG SHENGYI SCI.TECH CO., LTD, DONGGUAN CITY (CN)

(21) Appl. No.: 13/334,806

(22) Filed: Dec. 22, 2011

(30) Foreign Application Priority Data
Dec. 24, 2010 (CN) 201010605226.6

(51) Int. Cl. B32B 15/08; B05D 5/10; C08L 79/00; C08G 61/12; C08L 63/00

(52) U.S. Cl. 428/463; 525/534; 525/523; 523/400; 524/611; 427/207.1

(57) ABSTRACT

The present invention provides a cyanate ester resin composition, and a prepreg and a laminated made from the cyanate ester resin composition. The cyanate ester resin composition includes a cyanate ester resin containing the structure expressed by the following structure formula (1):

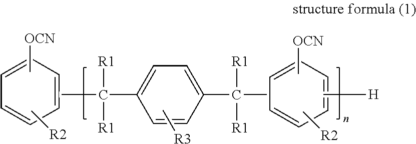

wherein, R1, R2 and R3 are hydrogen atom, alkyl or aralkyl; and n is an integer between 1 and 50. The cyanate ester resin composition of the present invention has excellent processability, thermal resistance and humidity resistance, and low water absorption, etc. The prepreg, the laminate, and the metal foil clad laminate made from the cyanate ester resin composition have excellent processability, thermal resistance and humidity resistance, and low water absorption, etc., thereby adapted for making substrate material of high density PCB, and have a very high industrial application value.

### FIELD OF THE INVENTION

The present invention relates to resin compositions, particularly to a cyanate ester resin composition, and a prepreg and a laminate made therefrom.

### BACKGROUND OF THE INVENTION

In recent years, with the development of high-properties, high function and networking of computers and information communication equipments, the much higher demands are put forward to PCB (Printed Circuit Board), such as high wiring density and high integration. This requires that the metal foil clad laminates for making PCBs have more excellent thermal resistance, humidity resistance, and reliability, etc.

Cyanate ester resin has excellent dielectric property, thermal resistance, mechanical property, and processability, which is one type of matrix resins of the metal foil clad laminates generally used to make high end PCB. In recent years, prepregs and laminates which are made from the resin (generally called “BT” resin) composition including bisphenol A type cyanate ester resin and maleimide compounds, are widely applied in high property PCB material for semiconductor package.

Bisphenol A type cyanate ester resin compositions have excellent thermal resistance, chemical resistance, and adhesive property, etc. However, the cured bisphenol A type cyanate ester resin compositions have the problem of high water absorption and insufficient humidity resistance, and the mechanical property such as elastic modulus of the bisphenol A type cyanate ester resin compositions can not meet the performance requirement of high end substrate.

Besides, the resin compositions used for making metal foil clad laminates generally are required to have flame retardancy, thereby bromine-containing flame retardants are generally added to the resin compositions simultaneously to achieve flame retardant. However, for people paying more attention to the environment, it is required to not use halogen-containing compounds to achieve flame retardant. At present, phosphorus compounds are used for flame retardant. However, various intermediates of the phosphorus compounds and the making process of the phosphorus compounds have a certain toxicity, the phosphorus compounds may generate toxic gases (such as methylphosphine) and toxic substances (such as triphenylphosphine), and the wastes may cause potential harm to the aquatic environment.

Therefore, in order to further improve the property of the cyanate ester resin composition, person skilled in the art has done a mass of technology research for a long time. The results of these studies are cited as follows:

DCPD type cyanate ester resin compositions have excellent dielectric property, thermal resistance and humidity resistance, and good mechanical property, are widely applied in high frequency circuit substrate, and high performance composite material, etc. It can make up for insufficient humidity resistance of the bisphenol A type cyanate ester resin compositions. But, the DCPD type cyanate ester resin compositions have poor flame retardancy. So it can not meet the performance requirement of high end substrate.

U.S. Pat. No. 7,655,871 disclosed a laminate, which is made by using phenol novolac type cyanate ester resin, biphenyl type epoxy resin and phenoxy resin as the matrix, using fiberglass cloth as intensifier, and adding a mass of silica as filler. Although it has excellent thermal resistance, and can achieve halogen-free flame retardant, but after the phenol novolac type cyanate ester resin has been cured under common technological condition, the cured resin has high water absorption and poor humidity resistance. And, the phenol novolac type cyanate ester resin itself has poor flame retardancy. To meet the requirement of halogen-free, phosphorus-free flame retardant, a mass of inorganic filler need to be added to achieve flame retardant, thereby its processability is reduced.

U.S. Pat. App. Pub. Nos. 2005/0182203 and 2006/0084787 disclosed two types of cyanate ester resins with new structure, i.e., biphenyl type cyanate ester resin and naphthol aralkyl type cyanate ester resin. The cured resins of the two types of cyanate ester resins have low water absorption, and excellent thermal resistance, humidity resistance and flame retardancy.

U.S. Pat. No. 7,601,429 disclosed a laminate, which is made by using naphthol aralkyl type cyanate ester resin and non-halogen epoxy resin as the matrix resin, using fiberglass cloth as intensifier, and adding boehmite and organic silicon resin powder as filler. U.S. Pat. App. Pub. No. 2009/0017316 disclosed a laminate, which is made by using naphthol aralkyl type cyanate ester resin, non-halogen epoxy resin and maleimide compounds as the matrix resin, using fiberglass cloth as intensifier, and adding fused silica and silicon resin powder as intensifier. Due to the naphthol aralkyl type cyanate ester resin composition having excellent humidity resistance and flame retardancy, there is no need to add a mass of inorganic filler to achieve halogen-free, phosphorus-free flame retardant. Thus it can well solve the problems of poor humidity resistance and flame retardancy, and reduced processability, etc., which are presented in the bisphenol A type, DCPD type and phenol novolac type cyanate ester resins.

However, the biphenyl type cyanate ester resin is easily crystallized out, which limits its application. The naphthol aralkyl type cyanate ester resin, for naphthalene nucleus existing in the molecular framework thereof, has good thermal resistance. But, its processability is reduced, thereby it can not meet the requirement for substrate material of high density PCB.

### SUMMARY OF THE INVENTION

An object of the present invention is to provide a cyanate ester resin composition, used as a material for PCB, which has low water absorption, good processability, thermal resistance and humidity resistance.

Another object of the present invention is to provide a prepreg and a laminate made from the cyanate ester resin composition, which have low water absorption, good processability, thermal resistance and humidity resistance, etc., adapted for making substrate material of high density PCB, and have a very high industrial application value.

To achieve the above mentioned objects, the present invention provides a cyanate ester resin composition, which includes a cyanate ester resin containing the structure expressed by the following structure formula (1):

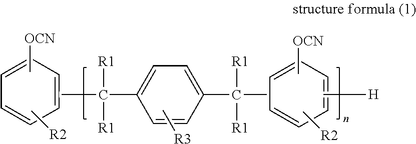

wherein, R1, R2 and R3 are hydrogen atom, alkyl or aralkyl; and n is an integer between 1 and 50.

The cyanate ester resin composition of the present invention further includes an epoxy resin, and the cyanate ester resin accounts for 10%-90% by weight of the sum of the cyanate ester resin and the epoxy resin.

The epoxy resin can be non-halogen epoxy resin.

The cyanate ester resin composition of the present invention further includes a powder filler.

Per 100 parts by weight of the sum of the cyanate ester resin and the epoxy resin coordinate with 10-300 parts by weight of the powder filler.

The cyanate ester resin composition of the present invention further includes at least one maleimide compound containing the structure expressed by the following structure formula (2):

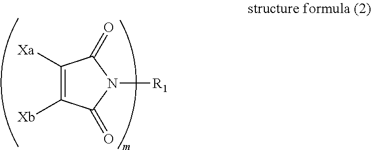

wherein, R1 is an organic group with the number of carbon atoms thereof being less than 200, or including oxygen atom, sulfur atom, phosphorus atom, nitrogen atom, or silicon atom; Xa and Xb are the same or different univalent atom or organic group selected from the group consisting of hydrogen atom, halogen atom, aliphatic organic group, alicyclic organic group and aromatic organic group; and m is an integer equal to or larger than 1.

The cyanate ester resin accounts for 20%-95% by weight of the sum of the cyanate ester resin and the maleimide compounds, and the maleimide compounds account for 5%-80% by weight of the sum of the cyanate ester resin and the maleimide compounds.

The present invention also provides a prepreg and a laminate made from the above mentioned cyanate ester resin composition. The prepreg includes a base material (substrate material), and the cyanate ester resin composition that adheres to the base material after the base material is impregnated in the cyanate ester resin composition and then is dried. The laminate includes at least one piece of prepreg. A metal foil is cladded to one side or each of the two sides of the laminate, and then the laminate is laminated and cured, thereby obtaining a metal foil clad laminate.

The advantages of the present invention: the cyanate ester resin composition of the present invention has good processability, thermal resistance and humidity resistance, and low water absorption, etc. The prepreg, the laminate, and the metal foil clad laminate made therefrom have excellent processability, thermal resistance and humidity resistance, and low water absorption etc., thereby adapted for making substrate material of high density PCB, and have a very high industrial application value.

### DESCRIPTION OF THE PREFERRED EMBODIMENTS

The present invention provides a cyanate ester resin composition, which includes a cyanate ester resin containing the structure expressed by the following structure formula (1):

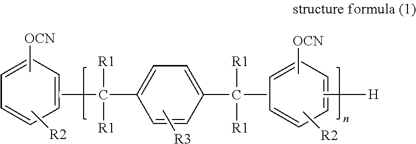

wherein, R1, R2 and R3 are hydrogen atom, alkyl or aralkyl; and n is an integer between 1 and 50. In the present invention, there is no special limitation on the cyanate ester resin, which is a cyanate ester resin expressed by structure formula (1) with each molecule thereof including at least two OCN groups or a prepolymer thereof. The cyanate ester resins can be used alone, or according to the need, at least two kinds of the cyanate ester resins can be mixed to use.

There is no special limitation on the synthesis method of the cyanate ester resin, and it can be selected from the making method known as synthesis method for cyanate ester resin. In detail, such as the following method to make the cyanate ester resin: in existence of alkaline compound, making the phenol aralkyl resin expressed by the following structure formula (3) and the cyanogen halogenide react in inert organic solvent to get the cyanate ester resin.

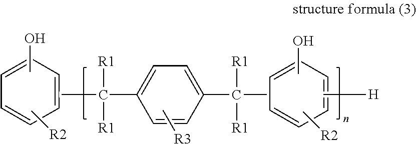

In structure formula (3): R1, R2 and R3 are hydrogen atom, alkyl or aralkyl; and n is an integer between 1 and 50.

The inventers of the present invention found that if epoxy resin is added to the cyanate ester resin with specific structure, the made resin composition has the following properties: excellent processability, thermal resistance and humidity resistance, and low water absorption. Therefore, the cyanate ester resin composition further includes an epoxy resin. In the present invention, there is no special limitation on the dosage of the cyanate ester resin. If the dosage of the cyanate ester resin is too low, the thermal resistance of the made laminate will be reduced; and if the dosage of the cyanate ester resin too high, the solubility and the degree of cured body thereof will be reduced. Therefore, the cyanate ester resin accounts for preferably 10%-90% by weight of the sum of the cyanate ester resin and the epoxy resin, particularly preferably 30%-70% by weight.

Wherein, there is no special limitation on the type of epoxy resin, which is a compound with each molecule thereof including at least two epoxy groups. Particularly, the epoxy resin is selected from bisphenol A type epoxy resin, bisphenol F type epoxy resin, phenol novolac type epoxy resin, cresol novolac type epoxy resin, bisphenol A novolac type epoxy resin, brominated bisphenol A type epoxy resin, brominated phenol type epoxy resin, trifunctional phenol type epoxy resin, tetrafunctional phenol type epoxy resin, naphthalene type epoxy resin, biphenyl type epoxy resin, dicyclopentadiene type epoxy resin, phenol aralkyl type epoxy resin, biphenyl aralkyl type epoxy resin, naphthol aralkyl type epoxy resin, alicyclic epoxy resin, polyol type epoxy resin, phosphorus-containing epoxy resins, silicon-containing epoxy resins, nitrogen-containing epoxy resins, glycidyl amine, glycidyl ester, and the compound made from butadiene or the like via epoxidation reaction of double bonds. Preferably, the epoxy resin is selected from bisphenol A type epoxy resin, bisphenol F type epoxy resin, phenol novolac type epoxy resin, cresol novolac type epoxy resin, bisphenol A novolac type epoxy resin, brominated bisphenol A type epoxy resin, brominated phenol type epoxy resin, naphthalene type epoxy resin, biphenyl type epoxy resin, dicyclopentadiene type epoxy resin, phenol aralkyl type epoxy resin, biphenyl aralkyl type epoxy resin, and naphthol aralkyl type epoxy resin. According to the need, the above mentioned epoxy resins can be used alone or in combination. There is no special limitation on the dosage of the epoxy resin. The epoxy resin accounts for preferably 10%-90% by weight of the sum of the cyanate ester resin and the epoxy resin, particularly preferably 30%-70% by weight.

The cyanate ester resin composition further includes a powder filler. The epoxy resin thereof can also be non-halogen epoxy resin. The inventers of the present invention further found that if non-halogen epoxy resin and non-halogen powder filler are added to the cyanate ester resin with specific structure, the made halogen-free flame retardant resin composition has the following properties: excellent processability, thermal resistance, humidity resistance and flame retardancy, and low water absorption. In the present invention, there is no special limitation on the non-halogen epoxy resin, which is a non-halogen compound with each molecule thereof including at least two epoxy groups. Particularly, the non-halogen epoxy resin is selected from bisphenol A type epoxy resin, bisphenol F type epoxy resin, phenol novolac type epoxy resin, cresol novolac type epoxy resin, bisphenol A novolac type epoxy resin, trifunctional phenol type epoxy resin, tetrafunctional phenol type epoxy resin, naphthalene type epoxy resin, biphenyl type epoxy resin, dicyclopentadiene type epoxy resin, phenol aralkyl type epoxy resin, biphenyl aralkyl type epoxy resin, naphthol aralkyl type epoxy resin, alicyclic epoxy resin, polyol type epoxy resin, phosphorus-containing epoxy resins, silicon-containing epoxy resins, nitrogen-containing epoxy resins, glycidyl amine, glycidyl ester, and the compound made from butadiene or the like via epoxidation reaction of double bonds. Preferably, the non-halogen epoxy resin is selected from phenol novolac type epoxy resin, naphthalene type epoxy resin, biphenyl type epoxy resin, phenol aralkyl type epoxy resin, biphenyl aralkyl type epoxy resin, naphthol aralkyl type epoxy resin, and phosphorus-containing epoxy resins. According to the need, the above mentioned non-halogen epoxy resins can be used alone or in combination. There is no special limitation on the dosage of the non-halogen epoxy resin. The non-halogen epoxy resin accounts for preferably 10%-90% by weight of the sum of the cyanate ester resin and the non-halogen epoxy resin, particularly preferably 30%-70% by weight.

There is no special limitation on the powder filler. The powder filler is selected from inorganic filler or organic filler to be generally used. Particularly, the inorganic filler is selected from: silicon, such as natural silica, amorphous silica, spherical silica and hollow silica; metal hydrates such as aluminum hydroxide, boehmite and magnesium hydroxide; molybdenum oxide; zinc molybdate; titanium oxide; strontium titanate; barium titanate; boron nitride; aluminium nitride; silica carbide; aluminum oxide; zinc borate; zinc hydroxystannate; clay; kaolin; talc; mica; short glass fiber; and hollow glass. The average diameter of the inorganic filler is 0.1-10 micron, preferably 0.2-5 micron. According to the purpose, the inorganic filler can be provided with different size distribution or different average diameter. Particularly, the organic filler is selected from: organic silicon powder; polytetrafluoroethylene; polyphenylene sulfide; polyether sulfone; brominated polystyrene; decabromodiphenyl ether; decabromdiphenylethane; ethylenebistetrabromophthalimide; melamine; tri(2,6-dimethylphenyl)phosphine; 10-(2,5-dihydroxyphenyl)-9,10-dihydrogen-9-oxa-10-Phosphenanthrene-10-oxide; 2,6-bis(2,6-dimethyl phenyl)phosphenyl; and 10-phenyl-9,10-dihydrogen-9-oxa-10-phosphenanthrene-10-oxide. In the present invention, there is no special limitation on the dosage of the powder filler. Per 100 parts by weight of the sum of the cyanate ester resin and the epoxy resin or the non-halogen epoxy resin coordinate with preferably 10-300 parts by weight of the powder filler, more preferably 30-200 parts by weight.

Wherein, the inorganic powder filler used in the present invention can be combined with surface treatment agent or wetting and dispersing agent. There is no special limitation on the surface treatment agent, and it can be the common surface treatment agent used for surface treating an inorganic compound. Particularly, the surface treatment agent is selected from: ethyl silicate compounds, organic acid compounds, aluminate compounds, titanate compounds, organic silicon oligomer, macromolecular treating agent, and silane-coupling agent. There is no special limitation on the silane-coupling agent, and it can be the common silane-coupling agent used for surface treating an inorganic compound. Particularly, the silane-coupling agent is selected from: amino silane coupling agent, epoxy group silane coupling agent, ethenyl silane coupling agent, phenyl silane coupling agent, cation silane coupling agent, and sulfydryl silane coupling agent. There is no special limitation on the wetting and dispersing agent, and it can be the common wetting and dispersing agent used in paints.

According to the need, curing promoting agent can be used along with the cyanate ester resin composition of the present invention to control curing reaction rate. There is no special limitation on the curing promoting agent, and it can be the curing promoting agent which is generally used for cyanate ester resin, epoxy resin and non-halogen epoxy resin. Particularly, the curing promoting agent is selected from: organic salt of the metal such as copper, zinc, cobalt, nickel, and manganese; imidazole and its derivatives; and tertiary amine.

Other cyanate ester resins besides the cyanate ester resin expressed by the above mentioned structure formula (1) can also be used along with the cyanate ester resin composition of the present invention, as long as it does not damage the inherent property of the cyanate ester resin composition. The other cyanate ester resins can be selected from the known cyanate ester resins, such as bisphenol A type cyanate ester resin, bisphenol F type cyanate ester resin, bisphenol M type cyanate ester resin, bisphenol E type cyanate ester resin, bisphenol P type cyanate ester resin, phenol novolac type cyanate ester resin, cresol novolac type cyanate ester resin, dicyclopentadiene type cyanate ester resin, tetramethyl bisphenol F type cyanate ester resin, aralkyl type cyanate ester resin, or prepolymer of these above mentioned cyanate ester resins. These cyanate ester resins can be used alone or in combination according to the need.

Maleimide compounds can be used along with the cyanate ester resin composition of the present invention. There is no special limitation on the maleimide compounds. The maleimide compounds are at least one maleimide compound containing the structure expressed by the aftermentioned structure formula (2). Preferably, the maleimide compound has at least two maleimide groups.

Various polymers can be used along with the cyanate ester resin composition of the present invention, such as different thermosetting resins and thermoplastic resins, and oligomer and rubber thereof, and different flame retardant compounds or additives, as long as they do not damage the inherent property of the cyanate ester resin composition. According to the need, these polymers can be used in combination.

Further, the inventers of the present invention found that if the cyanate ester resin with specific structure and the maleimide compounds are used in combination, the made resin composition has excellent elastic modulus and low water absorption. There is no special limitation on the maleimide compounds. the maleimide compound is at least one maleimide compound containing the structure expressed by the following structure formula (2):

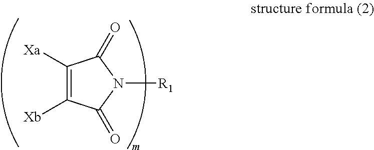

wherein, R1 is organic group with the number of carbon atoms thereof being less than 200, or including oxygen atom, sulfur atom, phosphorus atom, nitrogen atom, or silicon atom; Xa and Xb are the same or different univalent atom or organic group selected from the group consisting of hydrogen atom, halogen atom, aliphatic organic group, alicyclic organic group and aromatic organic group; and m is an integer equal to or larger than 1. In the present invention, preferably, the maleimide compound has at least two maleimide groups. The maleimide compound is selected from N-phenyl maleimide, N-(2-methylphenyl)maleimide, N-(4-methylphenyl)maleimide, N-(2,6-dimethylphenyl)maleimide, bis(4-maleimidephenyl)methane, 2,2-bis(4-(4-maleimidephenoxy)-phenyl)propane, bis (3,5-dimethyl-4-maleimidephenyl)methane, bis(3-ethyl-5-methyl-4-maleimidephenyl)methane, bis(3,5-diethyl-4-maleimidephenyl)methane, polyphenylmethylmaleimide, prepolymer of these above mentioned maleimide compounds, and prepolymer of maleimide compounds and amine compounds. According to the need, the maleimide compounds can be used alone or in combination.

In the present invention, there is no special limitation on the dosage of the maleimide compounds. If the dosage of the maleimide compounds is too low, the thermal resistance of the cured body obtained therefrom will be reduced. If the dosage of the maleimide compounds is too high, the humidity resistance of the cured body obtained therefrom will be reduced. Therefore, the maleimide compound accounts for preferably 5%-80% by weight of the sum of the cyanate ester resin and the maleimide compounds, particularly preferably 10%-70% by weight.

There is no special limitation on the making method of the cyanate ester resin composition. The making method includes: simply melt blending the cyanate ester resin with the maleimide compounds; dissolving the cyanate ester resin and the maleimide compounds in solvent, and then mixing together; transforming one or both of the cyanate ester resin and the maleimide compounds to oligomer, and then mixing together; and mixing the cyanate ester resin and the maleimide compounds together, and then transforming them to oligomer.

The cyanate ester resin composition will be self-cured by heating, and the known curing promoting agent can be added to promote the curing reaction. Curing promoting agent can be organic peroxides, azocompounds, imidazole compounds, tertiary amine compounds, phenol compounds, organic metal salts compounds, inorganic metal salts compounds, or organic tin compounds. The curing condition is different according to the factors such as proportion of the resin composition, and whether the curing promoting agent exists or not. For pre-reaction, the temperature of prepolymerization is set to 130° C. or less by choosing the curing promoting agent. To accomplish curing, generally the cyanate ester resin composition is heat cured at a temperature in range of from 100° C. to 300° C. for a predetermined time, thereby obtaining the cured product. In this case, there is no special limitation on the level of the curing pressure. Generally, the curing pressure is preferably controlled in the range of 25-70 Kg/cm². The cyanate ester resin composition including maleimide compounds of the present invention has excellent physical property, chemical property, and processability, thereby it can be used for PCB material, prepreg, laminate, and structural material, etc.

Epoxy resin can be used along with the cyanate ester resin composition including maleimide compounds of the present invention. There is no special limitation on the type of epoxy resin, which is a compound with each molecule thereof including at least two epoxy groups.

The cyanate ester resin composition having maleimide compounds of the present invention can further include various polymers, such as different thermosetting resins and thermoplastic resins, and oligomer and rubber thereof, and different flame retardant compounds or additives, as long as they do not damage the inherent property of the cyanate ester resin composition. According to the need, these polymers can be used in combination. Powder filler can be used along with the cyanate ester resin composition including maleimide compounds of the present invention. There is no special limitation on the powder filler, it is the same as the powder filler described above.

The present invention further provides a prepreg and a laminate made from the above mentioned cyanate ester resin composition. The prepreg includes a base material, and the cyanate ester resin composition that adheres to the base material after the base material is impregnated in the cyanate ester is resin composition and then is dried. The laminate includes at least one piece of prepreg. A metal foil is cladded to one side or each of the two sides of the laminate, and then the laminate is laminated and cured, thereby obtaining a metal foil clad laminate. The cyanate ester resin composition is the above mentioned cyanate ester resin composition, which includes cyanate ester resin, and epoxy resin, or non-halogen epoxy resin, or maleimide compounds.

Wherein, the prepreg, the laminate, and the metal foil clad laminate, which are made from the cyanate ester resin composition including cyanate ester resin and epoxy resin, have excellent processability, thermal resistance and humidity resistance, and low water absorption, etc., thereby adapted for making substrate material of high density PCB, and have a very high industrial application value.

The prepreg, the laminate, and the metal foil clad laminate, which are made from the cyanate ester resin composition including cyanate ester resin and non-halogen epoxy resin, in addition to have the same effect as the above cyanate ester resin composition including epoxy resin, and further have the following characters: having high flame retardancy without using bromine-containing flame retardant.

The laminate, which is made from the cyanate ester resin composition including cyanate ester resin and maleimide compounds, has good thermal resistance and elastic modulus, and low water absorption. It overcomes the shortcoming of the conventional resin composition including bisphenol A type cyanate ester resin and maleimide compounds. Thereby, it has a very high industrial application value.

In the present invention, there is no special limitation on the base material. The base material is selected from: inorganic fiber, such as E glass, D glass, S glass, NE glass and quartz; and organic fiber, such as polyimide, polyamide and polyester. Generally, the form of the base material is woven, non-woven cloth, roving, short fiber, or fiber paper. The base material after surface treatment with silane coupling agent or the like, and the woven after splitting treatment are preferred. Further, the organic film of polyimide, polyamide, polyester or the like can be used as base material.

The making method of the prepreg of the present invention is: combining the cyanate ester resin composition with the base material to make the prepreg. The laminate of the present invention can be made from the above mentioned prepreg via laminating and curing. In detail, the laminate is made according to the following method: placing one single piece of the above mentioned prepreg, or stacking at least two piece of the above mentioned prepreg together; according to the need, cladding metal foils to one surface or two surfaces of the single prepreg or the stacked prepregs; laminating and curing to obtain the laminate. There is no special limitation on the metal foils, it can be the common metal foils used as PCB material. The laminating condition can be the general laminating condition for laminates and multilayer board of PCB.

For the laminate made from the above mentioned cyanate ester resin composition, the testing results of the physical property thereof are further detailedly described with the following embodiments.

Now, the embodiments of the present invention are detailedly described as follows. The embodiments are not to limit the scope of the present invention.

Synthesis example: synthesis of phenol aralkyl type cyanate ester resin.

300 g of chloroform and 0.97 mol of cyanogen chloride are added to a three-neck flask, and then evenly stirred and mixed, keeping the temperature at −10° C. 86 g (OH groups content: 0.49 mol) phenol aralkyl resin (MEH-7800SS, softening point: 65° C., OH equivalent: 175 g/eq, produced by Meiwa Plastic Industries, Ltd., structural formula thereof expressed by the following structure formula (4)) and 0.72 mol triethylamine are dissolved in 700 g chloroform, and then evenly mixed to get a solution. The solution is slowly added in drops at −10° C. into the above mentioned chloroform solution of cyanogen chloride. The dripping time of the solution is more than 120 minutes. After finishing dripping, continue reaction for 3 hours, and then end the reaction. The salt produced by the reaction is filtrated by a funnel. The filtrate is washed with 500 milliliter of 0.1 mol/L hydrochloric acid, and then washed 5 times with deionized water to neutrality. Sodium sulfate is added to the isolated chloroform solution to remove the water in the chloroform solution, and then sodium sulfate is removed by filtrating. The chloroform solution is distilled at 70° C. to remove the chloroform solvent thereof, and then is subjected to reduced pressure distillation at 90° C., thereby getting the solid phenol aralkyl type cyanate ester resin, with the purity thereof being more than 99%, and the structural formula thereof is expressed by the following structure formula (5). When the product is measured by infrared spectrum analysis, a strong absorption peak is shown at 2265 cm⁻¹, which is the characteristic peak of infrared absorption of OCN groups. The gelation time of the resin is measured under 200° C., which is more than 10 minutes.

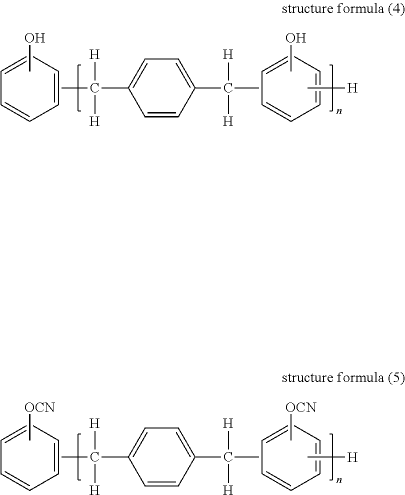

### Embodiment 1

Phenol aralkyl type cyanate ester resin made in the synthesis example in the amount of 70 parts by weight, bisphenol A type epoxy resin (EPICLON® 1055, produced by DIC Co., Ltd.) in the amount of 30 parts by weight, and zinc caprylate in the amount of 0.03 parts by weight are dissolved in butanone, and diluted to an appropriate viscosity with butanone, and then evenly stirred and mixed to obtain a glue solution. The fiberglass cloth 2166 is provided and impregnated with the glue solution. Then the fiberglass cloth is dried to remove the solvent, thereby forming a prepreg. Eight formed prepregs are overlapped, and two copper foils with thickness of 1 oz (ounce) separately cover on both top and bottom surfaces of the overlapped prepregs. The assembly of two copper foils and eight prepregs is put into a press machine to cure for 2 hours with curing pressure of 45 Kg/cm² and curing temperature of 220° C., thereby obtaining a copper foil clad laminate with thickness of 0.8 millimeter. The testing result of the physical property of the made copper foil clad laminate is shown in Table 1.

### Embodiment 2

Phenol aralkyl type cyanate ester resin made in the synthesis example in the amount of 50 parts by weight, biphenyl type epoxy resin (NC-3000H, produced by Nippon Kayaku Co., Ltd.) in the amount of 50 parts by weight, and zinc caprylate in the amount of 0.03 parts by weight are dissolved in butanone, and diluted to an appropriate viscosity with butanone, and then evenly stirred and mixed to obtain a glue solution. Then the follow-up process is the same as that in the embodiment 1, thereby obtaining a copper foil clad laminate with thickness of 0.8 millimeter. The testing result of the physical property of the made copper foil clad laminate is shown in Table 1.

### Embodiment 3

Phenol aralkyl type cyanate ester resin made in the synthesis example in the amount of 30 parts by weight, brominated phenol type epoxy resin (BREN-105, produced by Nippon Kayaku Co., Ltd.) in the amount of 35 parts by weight, o-cresol novolac type epoxy resin (EPICLON®N-673, produced by DIC Co., Ltd.) in the amount of 35 parts by weight, and zinc caprylate in the amount of 0.03 parts by weight are dissolved in butanone, and diluted to an appropriate viscosity with butanone, and then evenly stirred and mixed to obtain a glue solution. Then the follow-up process is the same as that in the embodiment 1, thereby obtaining a copper foil clad laminate with thickness of 0.8 millimeter. The testing result of the physical property of the made copper foil clad laminate is shown in Table 1.

### COMPARISON EXAMPLE 1

In comparison example 1, prepolymer of bisphenol A type cyanate ester resin (BA-230, produced by LONZA) in the amount of 70 parts by weight is provided to replace the phenol aralkyl type cyanate ester resin in the amount of 70 parts by weight of the embodiment 1. The others are the same as those in the embodiment 1, thereby obtaining a copper foil clad laminate with thickness of 0.8 millimeter. The testing result of the physical property of the made copper foil clad laminate is shown in Table 1.

### COMPARASION EXAMPLE 2

In comparison example 2, phenol novolac type cyanate ester resin (PT-30, produced by LONZA) in the amount of 70 parts by weight is provided to replace the phenol aralkyl type cyanate ester resin in the amount of 70 parts by weight of the embodiment 1. The others are the same as those in the embodiment 1, thereby obtaining a copper foil clad laminate with thickness of 0.8 millimeter. The testing result of the physical property of the made copper foil clad laminate is shown in Table 1.

TABLE 1
Physical Data of Embodiments 1-3 and Comparison Examples 1-2

| | | | | Compari- | Compari- |
|---|---|---|---|---|---|
| | Embodi- | Embodi- | Embodi- | son Ex- | son Ex- |
| | ment 1 | ment 2 | ment 3 | ample 1 | ample 2 |
| peel | 1.4 | 1.5 | 1.4 | 1.3 | 1.1 |
| strength, | | | | | |
| (N/mm) | | | | | |
| glass | 230 | 240 | 210 | 230 | 240 |
| transition | | | | | |
| temperature, | | | | | |
| (Tg, ° C.) | | | | | |
| thermal re- | ✓ | ✓ | ✓ | x | x |
| sistance after | | | | | |
| moisture | | | | | |
| absorption | | | | | |
| solder leach | >120 | >120 | >120 | >120 | >120 |
| resistance | | | | | |
| 288° C., (S) | | | | | |

### Embodiment 4

Phenol aralkyl type cyanate ester resin made in the synthesis example in the amount of 70 parts by weight, phenol novolac type epoxy resin (EPICLON® N-770, produced by DIC Co., Ltd.) in the amount of 30 parts by weight, aluminum hydroxide (OL-104 LEO, produced by Albemarle) in the amount of 100 parts by weight, epoxy group silane coupling agent (Z-6040, produced by Dow Coming) in the amount of 1 parts by weight, dispersing agent (BYK-W903, produced by BYK) in the amount of 1 parts by weight, and zinc caprylate in the amount of 0.03 parts by weight are dissolved in butanone, and diluted to an appropriate viscosity with butanone, and then evenly stirred and mixed to obtain a glue solution. The fiberglass cloth 2166 is provided and impregnated with the glue solution. Then the fiberglass cloth is dried to remove the solvent thereby forming prepregs. Eight formed prepregs are overlapped, and two copper foils with thickness of 1 oz (ounce) separately cover on both top and bottom surfaces of the overlapped prepregs. The assembly of two copper foils and eight prepregs is put into a press machine to cure for 2 hours with curing pressure of 45 Kg/cm² and curing temperature of 220° C., thereby obtaining a copper foil clad laminate with thickness of 0.8 millimeter. The testing result of the physical property of the made copper foil clad laminate is shown in Table 2.

### Embodiment 5

Phenol aralkyl type cyanate ester resin made in the synthesis example in the amount of 50 parts by weight, biphenyl type epoxy resin (NC-3000H, produced by Nippon Kayaku Co., Ltd.) in the amount of 50 parts by weight, boehmite (APYRAL AOH 30, produced by Nabaltec) in the amount of 100 parts by weight, epoxy group silane coupling agent (Z-6040, produced by Dow Corning) in the amount of 1 parts by weight, dispersing agent (BYK-W903, produced by BYK) in the amount of 1 parts by weight, and zinc caprylate in the amount of 0.03 parts by weight are dissolved in butanone, and diluted to an appropriate viscosity with butanone, and then evenly stirred and mixed to obtain a glue solution. Then, the follow-up process is the same as that in the embodiment 4, thereby obtaining a copper foil clad laminate with thickness of 0.8 millimeter. The testing result of the physical property of the made copper foil clad laminate is shown in Table 2.

### Embodiment 6

Phenol aralkyl type cyanate ester resin made in the synthesis example in the amount of 50 parts by weight, biphenyl type epoxy resin (NC-3000H, produced by Nippon Kayaku Co., Ltd.) in the amount of 40 parts by weight, naphthol alkyl type epoxy resin (ESN-175, produced by Tohto Kasei Co., Ltd.) in the amount of 10 parts by weight, spherical silica (SC-2050, produced by Admatechs) in the amount of 150 parts by weight, epoxy group silane coupling agent (Z-6040, produced by Dow Corning) in the amount of 1 parts by weight, dispersing agent (BYK-W903, produced by BYK) in the amount of 1 parts by weight, and zinc caprylate in the amount of 0.03 parts by weight are dissolved in butanone, and diluted to an appropriate viscosity with butanone, and then evenly stirred and mixed to obtain a glue solution. Then, the follow-up process is the same as that in the embodiment 4, thereby obtaining a copper foil clad laminate with thickness of 0.8 millimeter. The testing result of the physical property of the made copper foil clad laminate is shown in Table 2.

### Embodiment 7

Phenol aralkyl type cyanate ester resin made in the synthesis example in the amount of 40 parts by weight, biphenyl type epoxy resin (NC-3000H, produced by Nippon Kayaku Co., Ltd.) in the amount of 50 parts by weight, phenol aralkyl type epoxy resin (NC-2000L, produced by Nippon Kayaku Co., Ltd.) in the amount of 10 parts by weight, spherical silica (SC-2050, produced by Admatechs) in the amount of 150 parts by weight, organic silicon powder (TOSPEARL 120, produced by GE) in the amount of 20 parts by weight, epoxy group silane coupling agent (Z-6040, produced by Dow Corning) in the amount of 1 parts by weight, dispersing agent (BYK-W903, produced by BYK) in the amount of 1 parts by weight, and zinc caprylate in the amount of 0.03 parts by weight are dissolved in butanone, and diluted to an appropriate viscosity with butanone, and then evenly stirred and mixed to obtain a glue solution. Then, the follow-up process is the same as that in the embodiment 4, thereby obtaining a copper foil clad laminate with thickness of 0.8 millimeter. The testing result of the physical property of the made copper foil clad laminate is shown in Table 2.

### COMPARISON EXAMPLE 3

In comparison example 3, prepolymer of bisphenol A type cyanate ester resin (BA-230, produced by LONZA) in the amount of 50 parts by weight is provided to replace the phenol aralkyl type cyanate ester resin in the amount of 50 parts by weight of the embodiment 5. The others are the same as those in the embodiment 5, thereby obtaining a copper foil clad laminate with thickness of 0.8 millimeter. The testing result of the physical property of the made copper foil clad laminate is shown in Table 2.

### COMPARISON EXAMPLE 4

In comparison example 4, phenol novolac type cyanate ester resin (PT-30, produced by LONZA) in the amount of 50 parts by weight is provided to replace the phenol aralkyl type cyanate ester resin in the amount of 50 parts by weight of the embodiment 5. The others are the same as those in the embodiment 5, thereby obtaining a copper foil clad laminate with thickness of 0.8 millimeter. The testing result of the physical property of the made copper foil clad laminate is shown in Table 2.

TABLE 2
Physical Data of Embodiments 4-7 and Comparison Examples 3-4

| | Embodiment | Embodiment | Embodiment | Embodiment | Comparison | Comparison |
|---|---|---|---|---|---|---|
| | 4 | 5 | 6 | 7 | Example 3 | Example 4 |
| peel strength, | 1.4 | 1.5 | 1.5 | 1.4 | 1.4 | 1.1 |
| (N/mm) | | | | | | |
| thermal | ✓ | ✓ | ✓ | ✓ | x | x |
| resistance after | | | | | | |
| moisture | | | | | | |
| absorption | | | | | | |
| solder leach | >120 | >120 | >120 | >120 | >120 | >120 |
| resistance | | | | | | |
| 288° C. (S) | | | | | | |
| flame | V-0 | V-0 | V-0 | V-0 | burning | V-0 |
| retardancy | | | | | | |

### Embodiment 8

Phenol aralkyl type cyanate ester resin made in the synthesis example in the amount of 70 parts by weight, and 4,4′-Diphenylmethane bismaleimide (BM-200, produced by Otsuka Chemical) in the amount of 30 parts by weight are melt blended at 165° C. for 15 minutes. The melt blended composition is poured into a mould, defoamed at 165° C. for 20 minutes in vacuum circumstance, then heat cured at 180° C. for 4 hours, heat cured at 200° C. for 4 hours, and heat cured at 250° C. for 4 hours, thereby obtaining a cured body with thickness of 0.4 millimeter. The testing result of the physical property of the made cured body is shown in Table 3.

### Embodiment 9

Phenol aralkyl type cyanate ester resin made in the synthesis example in the amount of 50 parts by weight, and 4,4′-Diphenylmethane bismaleimide (BM-200, produced by Otsuka Chemical) in the amount of 50 parts by weight are melt blended at 165° C. for 15 minutes. Then, the follow-up process is the same as that in the embodiment 8, thereby obtaining a cured body with thickness of 4 millimeter. The testing result of the physical property of the made cured body is shown in Table 3.

### COMPARISON EXAMPLE 5

In comparison example 5, prepolymer of bisphenol A type cyanate ester resin (BA-230, produced by LONZA) in the amount of 70 parts by weight is provided to replace the phenol aralkyl type cyanate ester resin in the amount of 70 parts by weight of the embodiment 8. The others are the same as those in the embodiment 8, thereby obtaining a cured body with thickness of 4 millimeter. The testing result of the physical property of the made cured body is shown in Table 3.

### COMPARISON EXAMPLE 6

In comparison example 6, prepolymer of bisphenol A type cyanate ester resin (BA-230, produced by LONZA) in the amount of 50 parts by weight is provided to replace the phenol aralkyl type cyanate ester resin in the amount of 50 parts by weight of the embodiment 9. The others are the same as those in the embodiment 9, thereby obtaining a cured body with thickness of 4 millimeter. The testing result of the physical property of the made cured body is shown in Table 3.

TABLE 3
Physical Data of Embodiments 8-9 and Comparison Examples 5-6

| | | | Compari- | Compari- |
|---|---|---|---|---|
| | Embodi- | Embodi- | son Ex- | son Ex- |
| | ment 8 | ment 9 | ample 5 | ample 6 |
| rate of moisture | 2.7 | 3.5 | 8.5 | 9.6 |
| absorption, (%) | | | | |
| glass transition | 260 | 265 | 260 | 265 |
| temperature, (Tg, ° C.) | | | | |
| flexural modulus, (GPa) | 3.7 | 4.0 | 3.5 | 3.8 |

In summary, the cyanate ester resin composition of the present invention has excellent processability, thermal resistance and humidity resistance, and low water absorption, etc. The prepreg, the laminate, and the metal foil clad laminate made therefrom have excellent processability, thermal resistance and humidity resistance, and low water absorption, etc., thereby adapted for making substrate material of high density PCB, and have a very high industrial application value.

Although the present invention has been described in detail with above said embodiments, but it is not to limit the scope of the invention. So, all the modifications and changes according to the characteristic and spirit of the present invention, are involved in the protected scope of the invention.

What is claimed is:

1. A cyanate ester resin composition, comprising a cyanate ester resin containing the structure expressed by the following structure formula (1): 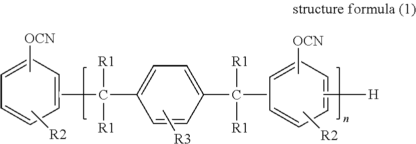
wherein, R1, R2 and R3 are hydrogen atom, alkyl or aralkyl; and n is an integer between 1 and 50.

2. The cyanate ester resin composition of claim 1, wherein the cyanate ester resin composition further comprises an epoxy resin, and the cyanate ester resin accounts for 10%-90% by weight of the sum of the cyanate ester resin and the epoxy resin.

3. The cyanate ester resin composition of claim 2, wherein the epoxy resin is non-halogen epoxy resin.

4. The cyanate ester resin composition of claim 2, wherein the cyanate ester resin composition further comprises a powder filler.

5. The cyanate ester resin composition of claim 4, wherein per 100 parts by weight of the sum of the cyanate ester resin and the epoxy resin coordinate with 10-300 parts by weight of the powder filler.

6. The cyanate ester resin composition of claim 1, wherein the cyanate ester resin composition further comprises at least one maleimide compound containing the structure expressed by the following structure formula (2): 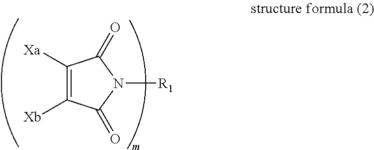
wherein, R1 is an organic group with the number of carbon atoms thereof being less than 200, or comprising oxygen atom, sulfur atom, phosphorus atom, nitrogen atom, or silicon atom; Xa and Xb are the same or different univalent atom or organic group selected from the group consisting of hydrogen atom, halogen atom, aliphatic organic group, alicyclic organic group and aromatic organic group; and m is an integer equal to or larger than 1.

7. The cyanate ester resin composition of claim 6, wherein the cyanate ester resin accounts for 20%-95% by weight of the sum of the cyanate ester resin and the maleimide compounds, and the maleimide compounds account for 5%-80% by weight of the sum of the cyanate ester resin and the maleimide compounds.

8. A prepreg comprising a base material and the cyanate ester resin composition of claim 1, the cyanate ester resin composition adhering to the base material after the base material being impregnated in the cyanate ester resin composition and then being dried.

9. A laminate comprising at least one piece of prepreg, the prepreg comprising a base material and the cyanate ester resin composition of claim 1, the cyanate ester resin composition adhering to the base material after the base material being impregnated in the cyanate ester resin composition and then being dried.

10. The laminate of claim 9, wherein a metal foil is cladded to one side or each of the two sides of the laminate, and then a metal foil clad laminate is formed by laminating and curing the laminate.
